(19) United States
(12) Patent Application Publication
(10) Pub. No.: US 2012/0004087 A1
(43) Pub. Date: Jan. 5, 2012

(54) DYNAMIC SHEET CURL/DECURL ACTUATOR

(75) Inventors: Marina Tharayil, Rochester, NY (US); Keith A. Buddendeck, Rochester, NY (US)

(73) Assignee: XEROX CORPORATION, Norwalk, CT (US)

(21) Appl. No.: 12/827,236

(22) Filed: Jun. 30, 2010

(51) Int. Cl. B31F 1/00

(52) U.S. Cl. 493/461

(57) ABSTRACT

An apparatus has a sheet path moving sheets of media within the apparatus and a curling/decurling station positioned along the sheet path. The curling/decurling station has a first set of rollers that impart or remove curl from a first type of sheets of media moving along the sheet path, and a second set of rollers that impart or remove curl from a second type of sheets of media moving along the sheet path. The first type of sheets have a different stiffness than the second type of sheets and are most effectively curled/decurled differently by the different sets of rollers.

### BACKGROUND

Embodiments herein generally relate to systems and methods that impart or remove curl from sheets of media and more particularly to systems and methods that utilize multiple mechanisms to adaptively impart or remove curl from different types of media.

Adjusting the curl on cut sheets has traditionally been done using one of two methods. The first method involves passing the sheet around a curved surface using localized high pressure and small bend radii to bend the sheets. This method is very effective on low stiffness sheets, but requires very high pressures for stiff sheets. A second method involves deforming the sheets by bending them beyond their elastic limits by passing them through curved baffles, thereby inducing curl on the sheets. This method is more effective on stiff and thick sheets than less stiff sheets.

### SUMMARY

In order to address these issues, the embodiments herein combine two curl actuation techniques into a single decurler station, which results in increased latitude and curl controllability. The design described below can take many forms, some of which are illustrated in the drawings. With embodiments herein, for lightweight (less-stiff) sheets, a high pressure nip is formed between a small, hard roll and a larger, elastomer or foam roll, to induce sheet curl. The hard roll causes indentation in the large roll's elastomer, creating a curved path for the paper passing through the nip. For heavier (and stiffer) sheets, sheets are forced through a curved path formed using three rolls. The three rolls create a curved path for paper travel, without using the pressures needed to deform the elastomer roll.

One exemplary embodiment herein is an apparatus that has a sheet path moving sheets of media within the apparatus and a curling/decurling station positioned along the sheet path. The curling/decurling station has a first set of rollers that impart or remove curl from a first type of sheets of media moving along the sheet path, and a second set of rollers that impart or remove curl from a second type of sheets of media moving along the sheet path. The first type of sheets have a different properties (stiffness and or thickness) than the second type of sheets and are most effectively curled/decurled differently by the different sets of rollers.

With embodiments herein, a controller is operatively connected to the first set of rollers and the second set of rollers. The controller controls the first set of rollers and the second set of rollers such that only the first set of rollers or the second set of rollers is applied to any given sheet. In other words, either the first set of rollers or the second set of rollers curls/decurls any given sheet, but not both.

At least one roller of the first set of rollers is movable toward or away from the sheet path to perform the curling/decurling action. Similarly, at least one roller of the second set of rollers is movable toward or away from the sheet path to allow the second set of rollers to perform the curling/decurling action.

The curling/decurling station is quite compact and can be manufactured so that the first set of rollers and the second set of rollers are separated by a distance less than a length of one sheet of the sheets of media.

In another embodiment (serial embodiment) the first set of rollers comprises a first roller on a first side of the sheet path and a second roller on a second side of the sheet path. Thus, the first roller and the second roller are positioned on opposite sides of the sheet path such that the sheet path is positioned between the first roller and the second roller. The first roller has a larger circumference than the second roller and the first roller is softer (more easily deformed) than the second roller. In this embodiment, the second set of rollers comprises a pair of rollers (e.g., “third” rollers) that are positioned on the first side of the sheet path, and another roller (e.g., “fourth” roller) is on the second side of the sheet path. The fourth roller is positioned between the third rollers relative to a processing direction of the sheet path.

In another embodiment that uses a three-roll design, the first roller and the second roller are again positioned on opposite sides of the sheet path and the first roller has a larger circumference than the second roller. The first roller is designed to deform under high pressure by the second roller. However, in this embodiment the second set of rollers comprise the first roller on the first side of the sheet path and a third roller on the second side of the sheet path. In this embodiment, the second roller is positioned between the first roller and the third roller relative to a processing direction of the sheet path.

In an additional embodiment (four-roll embodiment) the first roller and the second roller are positioned directly across from each other on opposite sides of the sheet path. Again, the first roller has a larger circumference and is softer on the periphery than the second roller. In this embodiment, the second set of rollers comprises a pair of third rollers on the first side of the sheet path, and the second roller positioned on the second side of the sheet path. In this embodiment, the first roller and the second roller are positioned between the third rollers relative to the processing direction of the sheet path.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIGS. 1A and 1B are side-view schematic diagrams of curling/decurling devices according to embodiments herein;

FIGS. 2A and 2B are side-view schematic diagrams of curling/decurling devices according to embodiments herein;

FIGS. 3A and 3B are side-view schematic diagrams of curling/decurling devices according to embodiments herein;

FIG. 4 is a chart illustrating relationships between paper weight and curling characteristics;

FIG. 5 is a chart illustrating relationships between paper weight and curling characteristics;

FIGS. 6A, 6B, and 6C are side-view schematic diagrams of curling/decurling devices according to embodiments herein;

FIGS. 7A, 7B, and 7C are side-view schematic diagrams of curling/decurling devices according to embodiments herein;

FIGS. 8A, 8B, and 8C are side-view schematic diagrams of curling/decurling devices according to embodiments herein;

FIGS. 9A, 9B, and 9C are side-view schematic diagrams of curling/decurling devices according to embodiments herein; and

FIG. 10 is a schematic diagram of a printing device according to embodiments herein.

### DETAILED DESCRIPTION

Adjusting the curl in a sheet is one of many functions performed by modern printing devices. Curling can be used to take out excess curl from sheets after image placement and fusing, or to add curl on sheets to conform to a vacuum drum or platen. Traditionally, curling/decurling has been achieved using one of several techniques including deformation and indentation.

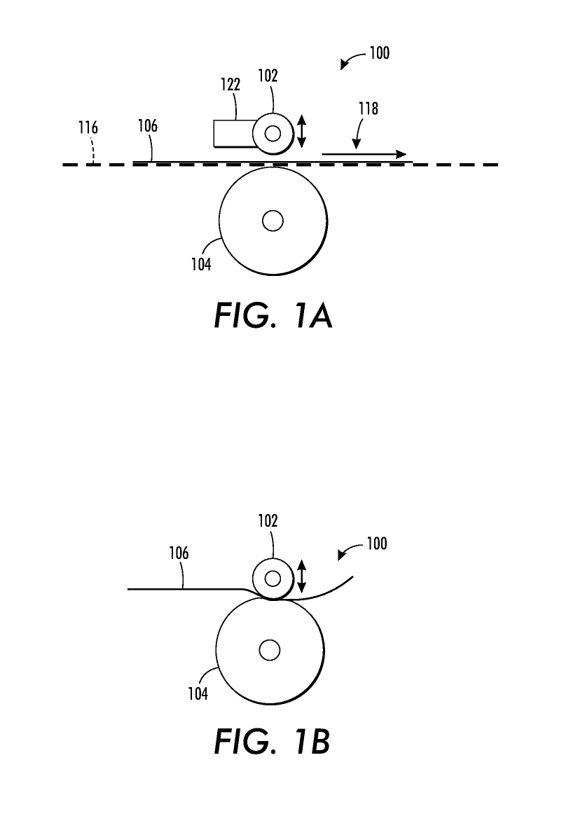

FIG. 1A illustrates a sheet of media 106 within an apparatus 100 that travels along a sheet path 116 in a processing direction 118 (which could be reversed in some embodiments) between a relatively smaller and harder roller 102 and a relatively softer (higher elastomer) and larger roller 104. The terms “roll” and “roller” are used interchangeably herein to describe a rotating member with a rounded outer surface. Further, in the embodiments herein, roller 104 is sometimes referred to as the “first” roller and roller 102 is sometimes referred to as the “second” roller.

As explained in U.S. Pat. No. 5,270,778 (the complete disclosure of which is incorporated herein by reference) an indentation curler/decurler mechanism 100 can include a relatively smaller radius, relatively harder roll 102 such as a metal (steel) shaft engaged by a relatively softer, relatively larger roll 104, for example having a compressible rubber surface which is moved toward the smaller roll 102 forming a nip where the two contact one another.

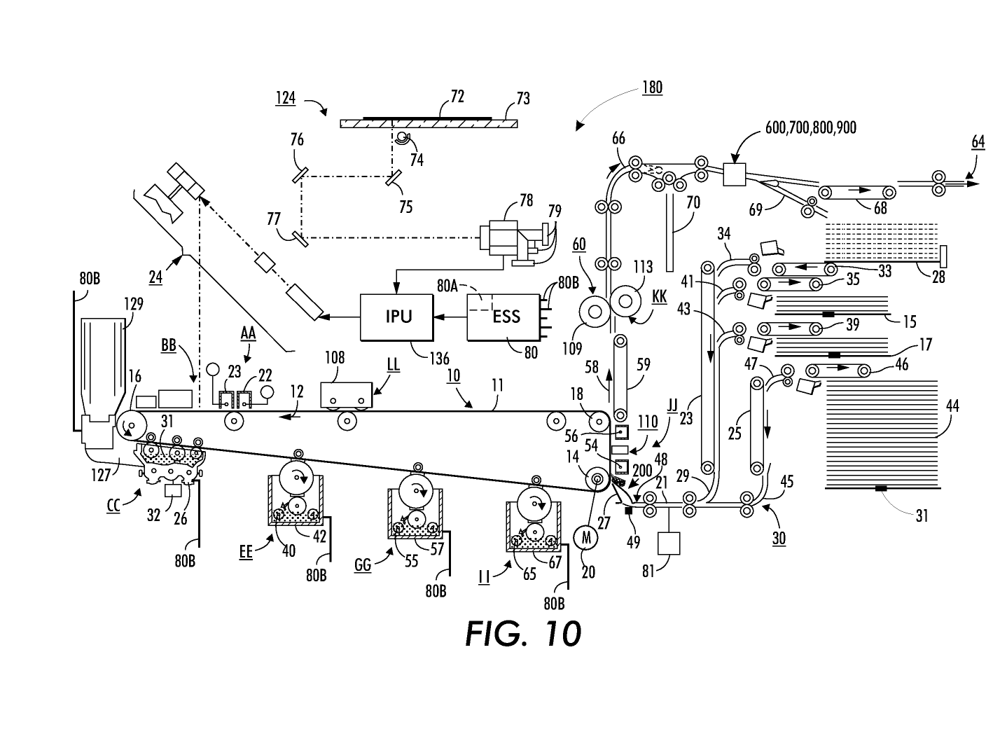

As shown by the double arrow in FIG. 1A, the harder roller 102 can move toward and away from (relative to) the sheet path 116 (and relative to the lower roller 104) in a direction that is perpendicular to the processing direction 118. The movement of the harder roller 102 is controlled by an actuator and controller 122 connected to the harder roller 102. The actuator 122 can comprise any form of movement device including, a stepper motor, a driven cam, a piston, a solenoid, etc., as would be understood by those ordinarily skilled in the art, the controller can be part of the actuator, or can be a separate controller (e.g., ESS unit 80 shown in FIG. 10 below) connected to the actuator 122 to control the movement of the harder roller 102.

The softer roller 104 deforms when the harder roller 102 is driven into the softer roller 104. If the sheet of media 106 is within the nip between the softer roller 104 and the harder roller 102, this causes the sheet 106 to indent around the harder roller 102, thereby creating a curl or curvature within the sheet 106. Alternatively, as would be understood by those ordinarily skilled in the art, if a curvature previous exists within the sheet 106, this structure can remove the curvature from the sheet if sufficient pressure is applied.

Note that, to avoid clutter in the remaining drawings, the processing direction 118 and actuator 122 are not illustrated but, as would be understood by those ordinarily skilled in the art, are items that are present in all structures described herein.

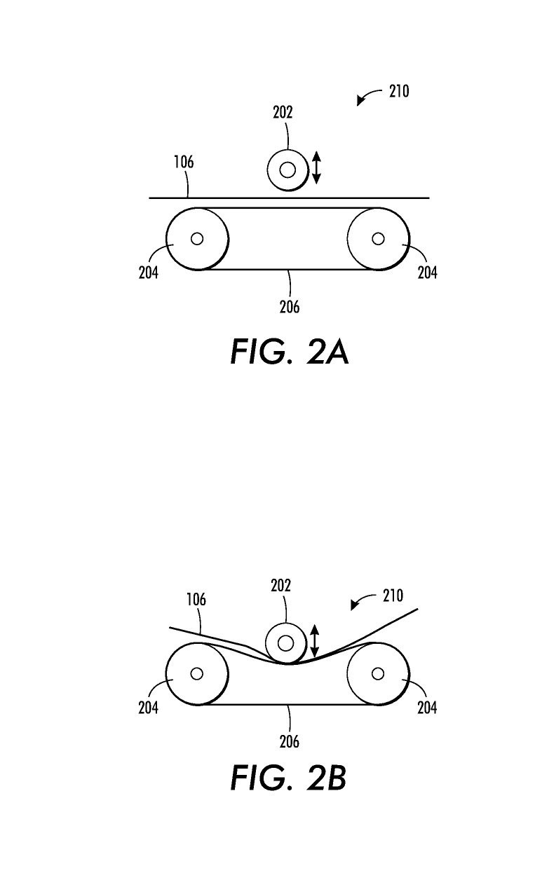

FIGS. 2A and 2B illustrate another curler/decurler mechanism 210 that utilizes a top roller 202 that is movable by the actuator 122 toward and away from a flexible belt 206 supported by rollers 204. A somewhat similar belt system is discussed in detail in U.S. Pat. No. 5,555,083, the complete disclosure of which is incorporated herein by reference. Here the top roller 202 is harder than the flexible belt 206. Therefore, as shown in FIG. 2B, when the top roller 202 presses into the belt 206 (in a similar manner to the harder roller 102 pressing into the softer roller 104) the sheet 106 curves around roller 202 and is thereby indented, which curls or decurls the sheet 106, in a similar manner as discussed above.

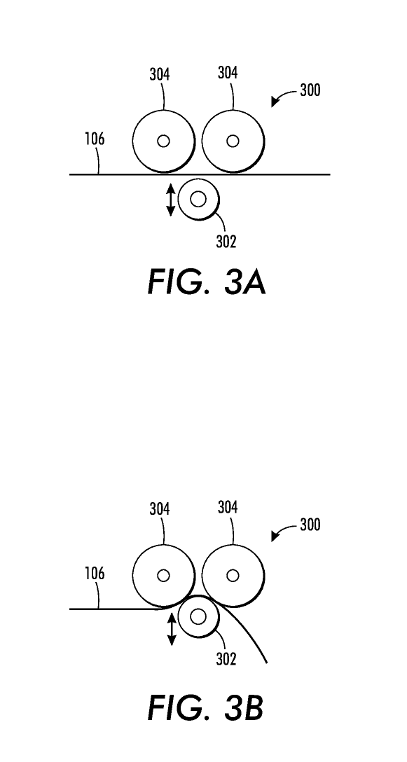

FIGS. 3A and 3B illustrate another curler/decurler mechanism 300 that utilizes three rollers 302, 304 which, in this embodiment, may or may not have the same hardness and may or may not be the same size. A conventional curl/decurl mechanism that has some similarities to the structure illustrated in FIGS. 3A-3B is disclosed in U.S. Pat. No. 4,326,915, the complete disclosure of which is incorporated herein by reference. In different embodiments herein, the upper rollers 304 are sometimes referred to as the “third” rollers and the lower roller 302 is sometimes referred to herein as the “fourth” roller.

In this mechanism 300, the lower roller 302 is again a movable by the actuator 122 and can be pressed against the upper rollers 304. In this embodiment, the relative positions of the three rollers cause the sheet 106 to bend around the lower roller 302, which creates a deformation in the sheet, causing the sheet 106 to curve or curl (as illustrated in FIG. 3B).

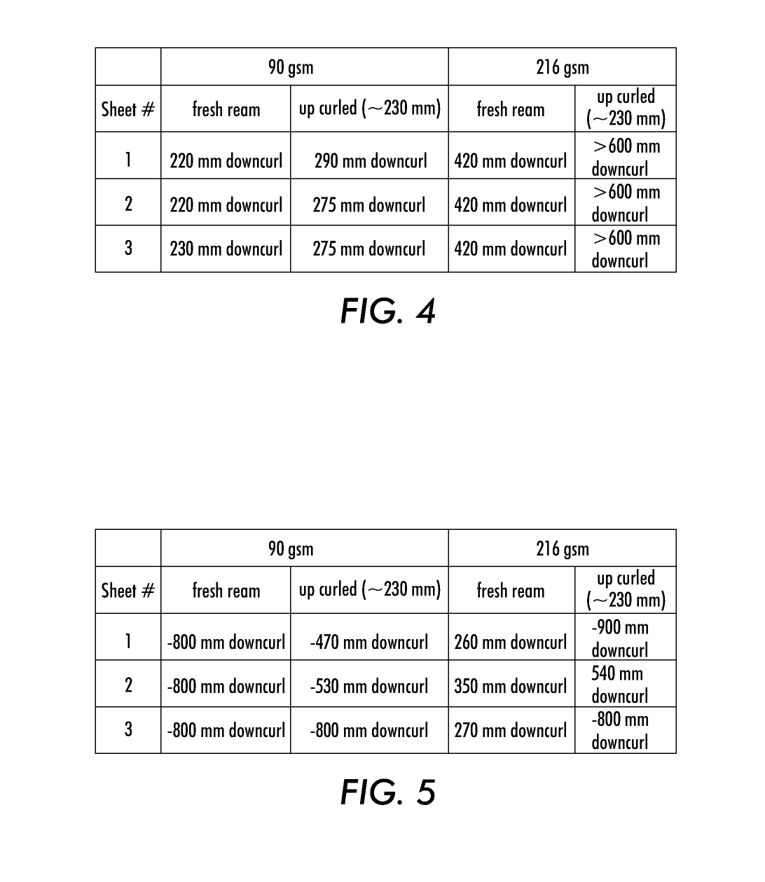

The indentation curler/decurler structures shown in FIGS. 1A-1B and 2A-2B rely mostly on sheet strain induced by localized pressure as the sheet is driven in the process direction. This method is more effective on light-weight and less stiff sheets, as shown by the data in FIG. 4. More specifically, FIG. 4 shows the hanging curl measured after sheets were passed through an indentation decurler (down curl) at a given setting. In FIG. 4, 90 gsm (grams per square meter) sheets were used as a lightweight example, and 216 gsm sheets were used to represent heavy weight sheets. The lightweight sheets with no input curl resulted in approximately 220 mm downcurl, whereas heavier sheets which were flat came out with about 420 mm down curl at the same setting. Similarly, feeding pre-curled sheets (in the opposite direction as the curler setting) resulted in higher curl actuation for the light-weight sheets. As the nip penetration increases, the drive motor is subjected to higher torque loads.

On the other hand, deformation curler/decurler designs, such as those shown in FIGS. 3A and 3B rely mostly on a sheet's self induced strain as it is forced around a tight bend. Sheets are driven by upstream and downstream nips, with the 3 roll design serving to create a bend in the sheet travel direction. This method is more effective on heavyweight and stiff sheets, as shown by the data in FIG. 5. More specifically, FIG. 5 shows results from passing flat and pre-curled sheets through a deformation curler device. Hanging curls were measured before and after. As can be seen from the data in FIG. 5, the curler/decurler is much more effective in inducing downcurl on the heavier and stiffer 216 gsm sheets than the lighter and thinner 90 gsm sheets.

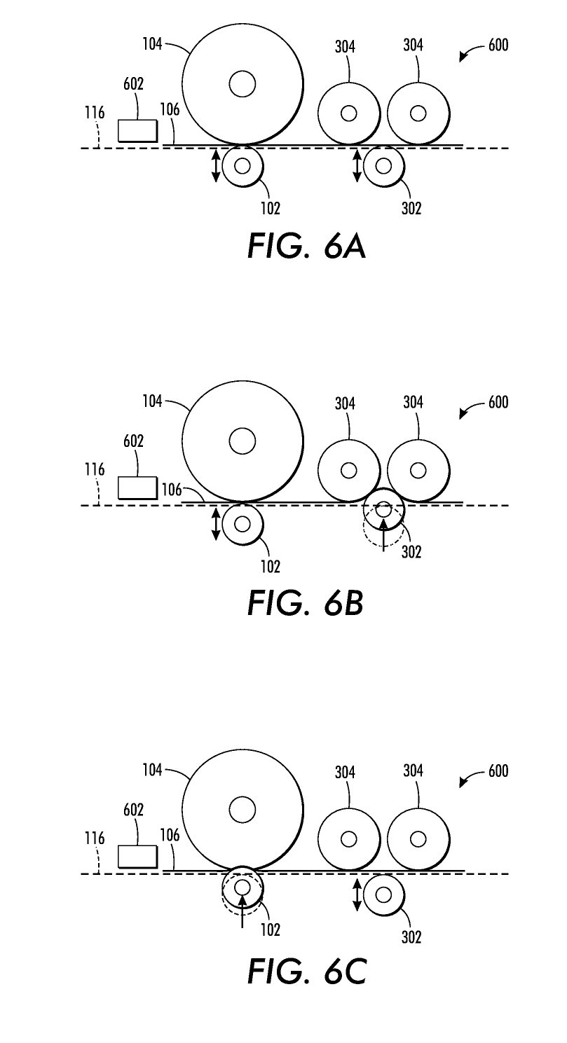

In the face of the ever-present need to increase media latitude, either of the above designs can have limitations. Therefore, in the embodiments shown in FIGS. 6A-9C, the curler/decurler design utilizes a combination of indentation and deformation mechanisms to generate curl controllability for a wide range of media, without excessive pressures or drive forces. The embodiments shown below utilize soft roll penetration to curl light-weight sheets, and three-roll media wrap around for heavy weight sheets. This increases media latitude without increasing high nip pressures or drive torques.

The embodiment shown in FIGS. 6A-6C is an apparatus that has a sheet path 116 moving sheets of media 106 within the apparatus and a curling/decurling station 600 positioned along the sheet path. The curling/decurling station has a first set of rollers 102, 104 that impart or remove curl from a first type of sheets of media 106 moving along the sheet path, and a second set of rollers 302, 304 that impart or remove curl from a second type of sheets of media 106 moving along the sheet path. The first type of sheets have a different stiffness (and/or thickness weight, etc.,) than the second type of sheets and are most effectively curled/decurled differently by the different sets of rollers.

The embodiment shown in FIGS. 6A-6C is sometimes referred to as the “serial” embodiment because the second set of rollers 302, 304 are in series with the first set of rollers 102, 104.

As with the structure shown in FIGS. 1A-1B, the first set of rollers has a first roller 104 that has a larger circumference than the second roller 102 and the first roller 104 is softer (more easily deformed) than the harder second roller 102. The first roller 104 and the second roller 104 are positioned on opposite sides of the sheet path 116 such that the sheet path 116 is positioned between the first roller 104 and the second roller 102.

As with the structure shown in FIGS. 3A-3B, the second set of rollers uses a pair of third rollers 304 that are positioned on the first side of the sheet path 116, and another roller (e.g., fourth roller) 302 on the second side of the sheet path 116. The fourth roller 302 is positioned between the third rollers 304 relative to the processing direction of the sheet path 116.

As shown in FIG. 6B, at least one roller 102 of the first set of rollers is movable toward or away from the sheet path (in a direction perpendicular to the sheet path 116) to perform the curling/decurling action. Similarly, as shown in FIG. 6C, at least one roller 302 of the second set of rollers is movable toward or away from the sheet path (again in a direction perpendicular to the sheet path 116) to allow the second set of rollers 302, 304 to perform the curling/decurling action.

With embodiments herein, the controller 122 or 80 is operatively connected to the first set of rollers 102, 104 and the second set of rollers 302, 304. The controller controls the first set of rollers 102, 104 and the second set of rollers 302, 304 such that (in many embodiments) only one of the sets of rollers is applied to any given sheet. In other words, either the first set of rollers 102, 104 or the second set of rollers 302, 304 curls/decurls any given sheet, but not both. The controller 122 or 80 chooses which sets of rollers to apply to a sheet depending upon the stiffness, thickness, weight, etc., of the sheet. This stiffness/thickness can be measured using one or more sensors 602 which can be positioned at any point along the sheet path 116. For example, the sensor 602 can be positioned immediately adjacent the curler/decurler apparatus 600 or can be positioned at some distance from the apparatus 600 (in the paper storage bin, etc.). Further, the sensors 602 can comprise any appropriate sensor (thickness measurement sensor, weight sensor, machine readable code sensor, etc.). For a fuller discussion of such sensors, see U.S. Pat. No. 5,519,481, the complete disclosure of which is incorporated herein by reference. Alternatively, the user can enter the stiffness/thickness value or the same can be supplied to the apparatus 600 through a network connection, etc.

If a sheet having a property (stiffness, thickness, or weight, etc.,) value above a predetermined limit is being processed through the curling/decurling apparatus 600, the controller 122 or 80 can elect to perform a deformation process on the sheet 106 using the second set of rollers 302, 304 as shown in FIG. 6B. Alternatively, if the stiffness, thickness, weight, etc., value of the sheet 106 is below the predetermined limit, the controller 122 or 80 can elect to perform an indentation process on the sheet 106 using the first set of rollers 102, 104 as shown in FIG. 6C. In certain situations, both types of curling/decurling can be performed on the same sheet of media as it passes through the stations 600, 700, 800, 900 herein.

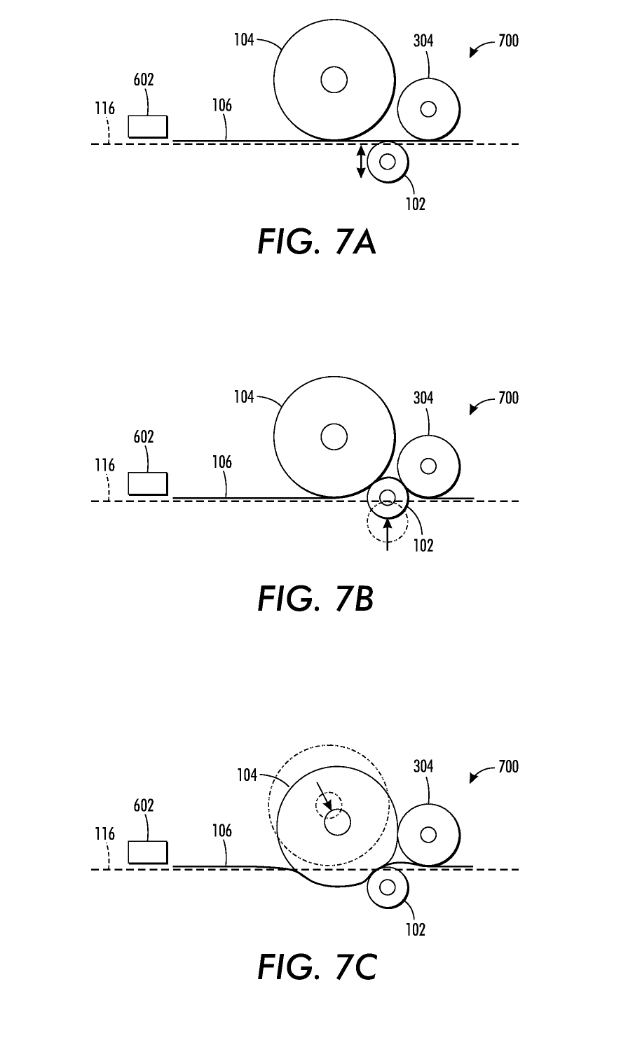

The embodiment shown in FIGS. 7A-7C is similar to the previous embodiment in that it combines both indentation and deformation elements, and is sometimes referred to herein as the three-roll design. In the three-roll design, the first roller 104 and the second roller 102 are again positioned on opposite sides of the sheet path and the first roller 104 has a larger circumference and is softer than the second roller 102. However, in this embodiment the second set of rollers comprises the first roller 104 on the first side of the sheet path and the third roller 304 on the second side of the sheet path. In this embodiment, the second roller 102 is positioned between the first roller 104 and the third roller 304 relative to the processing direction of the sheet path. This embodiment can also optionally include the sensor 602, discussed above.

As shown in FIG. 7B, the second roller 102 moves toward the other two rollers 104, 304 (so as to move between the rollers 104, 304) in a manner somewhat similar to that shown in FIG. 3B, discussed above, to perform a deformation operation. However, as shown in FIG. 7C, the same rollers can be used in an indentation operation by moving roller 104 toward roller 102 (in a diagonal direction relative to the sheet path 116) in a manner somewhat similar to that shown in FIG. 1B, discussed above.

As used herein, the term perpendicular movement means movement at an angle that is approximately (within a small percentage, e.g., <5%, 10%, etc. of) 90° with respect to a given plane (e.g., plane of paper path 116). To the contrary, the term diagonal means movement at an angle other than approximately 90° with respect to the given plane (e.g., 80°, 60°, 45°, 33°, 25°, etc.,).

As with the previously discussed curling/decurling apparatus 600, if a sheet having a stiffness, thickness, or weight, etc., value above a predetermined limit is being processed through the curling/decurling apparatus 700, the controller 122 or 80 can elect to perform a deformation process on the sheet 106 using the second set of rollers 102, 104, and 304 as shown in FIG. 7B. Alternatively, if the stiffness, thickness, weight, etc., value of the sheet 106 is below the predetermined limit, the controller 122 or 80 can elect to perform an indentation process on the sheet 106 using the first set of rollers 102, 104 as shown in FIG. 7C.

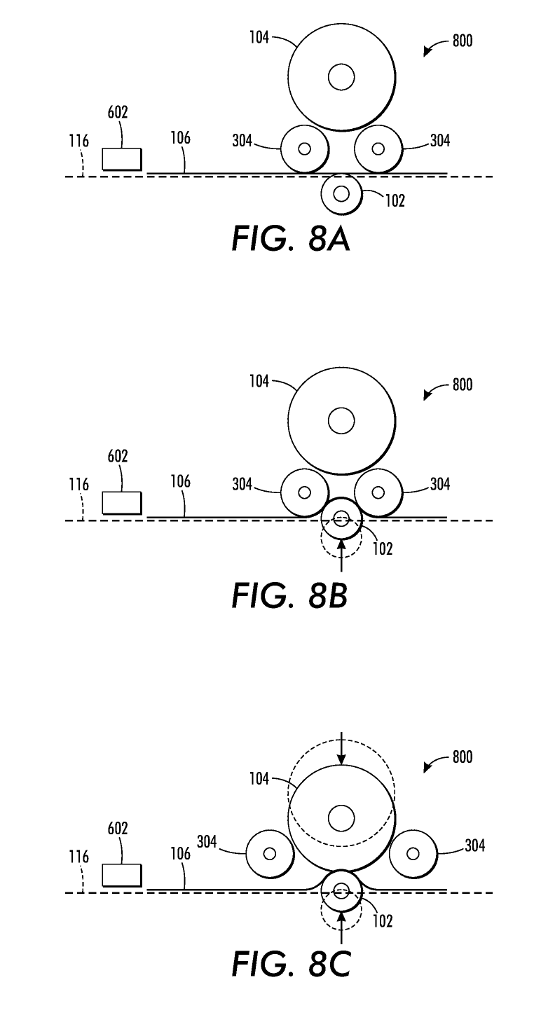

In an additional embodiment shown in FIGS. 8A-8C, which is sometimes referred to herein as a four-roll embodiment, the first roller 104 and the second roller 102 are positioned directly across from each other on opposite sides of the sheet path. Again, the first roller 104 is softer and has a larger circumference than the second roller 102, in a somewhat similar manner to the structure shown in FIG. 1A-1B. However, in this embodiment, the second set of rollers comprises a pair of third rollers 304 on the first side of the sheet path, and the second roller 102 positioned on the second side of the sheet path. In this embodiment, the first roller 104 and the second roller 102 are positioned between the third rollers 304 relative to the processing direction of the sheet path. This embodiment can also optionally include the sensor 602, discussed above.

As shown in FIG. 8B, the deformation process is performed by moving the second roller 102 toward the third rollers 304 while the third rollers 304 remain in position. The structure accomplishes the deformation process of the sheet 106 in a similar manner as the structure shown above in FIG. 3B. To perform the indentation operation, the third rollers 304 move diagonally with respect to the sheet path 116 as illustrated in FIG. 8C, after which the first roller 104 and the second roller 102 move in a direction perpendicular to the sheet path 116 toward one another. This roller movement positions the first roller 104 and second roller 102 in the same position as illustrated in FIG. 1B, thereby creating indentation within the sheet 106.

As with the previously discussed curling/decurling apparatus 600, if a sheet having a stiffness, thickness, or weight, etc., value above a predetermined limit is being processed through the curling/decurling apparatus 800, the controller 122 or 80 can elect to perform a deformation process on the sheet 106 using the second set of rollers 102, 304 as shown in FIG. 8B. Alternatively, if the stiffness, thickness, weight, etc., value of the sheet 106 is below the predetermined limit, the controller 122 or 80 can elect to perform an indentation process on the sheet 106 using the first set of rollers 102, 104 as shown in FIG. 8C.

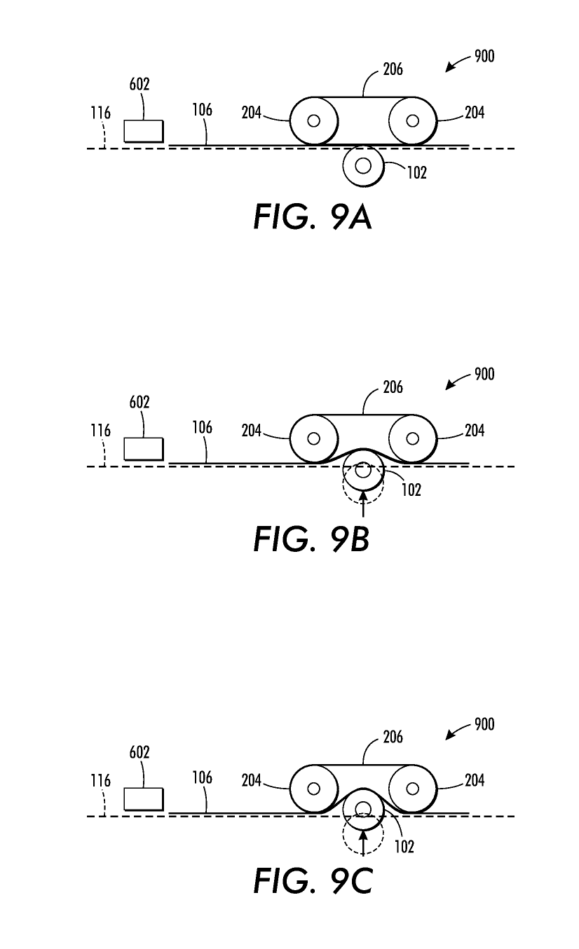

Another embodiment illustrated in FIGS. 9A-9C controls the amount of pressure applied to achieve either indentation or deformation. More specifically, the structure 900 shown in FIG. 9A is similar to the structure illustrated in FIG. 2A. In this embodiment (as shown in FIG. 9B) if a sheet has a stiffness, thickness, or weight, etc., value below the predetermined limit, the controller 122 or 80 can elect to perform an indentation process on the sheet 106 by moving the roller 202 against the belt 206 to apply a first amount of pressure against the sheet. To the contrary (as shown in FIG. 9C) if a sheet has a stiffness, thickness, or weight, etc., value above the predetermined limit, the controller 122 or 80 can elect to perform an indentation process on the sheet 106 by moving the roller 202 against the belt 206 to apply a second amount of pressure against the sheet that is greater than the first amount of pressure applied in FIG. 9B.

In all of the embodiments illustrated in FIGS. 6A-9C, as described above, the various rollers are moved from one position to another utilizing actuators 122 and controllers 80. Again, such items are not illustrated in every drawing to avoid clutter and to allow the salient features of the embodiments to be clearly illustrated. Also, the controller can take in paper properties and actuate one or the other rolls as appropriate. The indentation/penetration setting is dependent on the paper properties and desired curl levels.

As shown in FIGS. 6A-9C, the curling/decurling station is quite compact and can be manufactured so that the first set of rollers and the second set of rollers are separated by a small distance (e.g., less than a length of one sheet of the sheets of media).

With respect to a multi-function printing device embodiment, more specifically, FIG. 10 illustrates an exemplary electrostatic reproduction machine, for example, a multipass color electrostatic reproduction machine 180. As is well known, the color copy process typically involves a computer generated color image which may be conveyed to an image processor 136, or alternatively a color document 72 which may be placed on the surface of a transparent platen 73. A scanning assembly 124, having a light source 74 illuminates the color document 72. The light reflected from document 72 is reflected by mirrors 75, 76, and 77, through lenses (not shown) and a dichroic prism 78 to three charged-coupled linear photosensing devices (CCDs) 79 where the information is read. Each CCD 79 outputs a digital image signal the level of which is proportional to the intensity of the incident light. The digital signals represent each pixel and are indicative of blue, green, and red densities. They are conveyed to the IPU 136 where they are converted into color separations and bit maps, typically representing yellow, cyan, magenta, and black. IPU 136 stores the bit maps for further instructions from an electronic subsystem (ESS).

The ESS is a self-contained, dedicated mini-computer having a central processor unit (CPU), computer readable storage medium (memory), and a display or graphic user interface (GUI) 83. The ESS is the control system which, with the help of sensors 614, and connections 80B as well as a pixel counter 80A, reads, captures, prepares and manages the image data flow between IPU 136 and image input terminal 124. Note that in FIG. 10, not all wiring and connections are illustrated to avoid clutter. In addition, the ESS 80 is the main multi-tasking processor for operating and controlling all of the other machine subsystems and printing operations. These printing operations include imaging, development, sheet delivery and transfer, and particularly control of the sequential transfer assist blade assembly. Such operations also include various functions associated with subsequent finishing processes. Some or all of these subsystems may have micro-controllers that communicate with the ESS 80.

The multipass color electrostatic reproduction machine 180 employs a photoreceptor 10 in the form of a belt having a photoconductive surface layer 11 on an electroconductive substrate. The surface 11 can be made from an organic photoconductive material, although numerous photoconductive surfaces and conductive substrates may be employed. The belt 10 is driven by means of motor 20 having an encoder attached thereto (not shown) to generate a machine timing clock. Photoreceptor 10 moves along a path defined by rollers 14, 18, and 16 in a counter-clockwise direction as shown by arrow 12.

Initially, in a first imaging pass, the photoreceptor 10 passes through charging station AA where a corona generating devices, indicated generally by the reference numeral 22, 23, on the first pass, charge photoreceptor 10 to a relatively high, substantially uniform potential. Next, in this first imaging pass, the charged portion of photoreceptor 10 is advanced through an imaging station BB. At imaging station BB, the uniformly charged belt 10 is exposed to the scanning device 24 forming a latent image by causing the photoreceptor to be discharged in accordance with one of the color separations and bit map outputs from the scanning device 24, for example black. The scanning device 24 is a laser Raster Output Scanner (ROS). The ROS creates the first color separatism image in a series of parallel scan lines having a certain resolution, generally referred to as lines per inch. Scanning device 24 may include a laser with rotating polygon minor blocks and a suitable modulator, or in lieu thereof, a light emitting diode array (LED) write bar positioned adjacent the photoreceptor 10.

At a first development station CC, a non-interactive development unit, indicated generally by the reference numeral 26, advances developer material 31 containing carrier particles and charged toner particles at a desired and controlled concentration into contact with a donor roll, and the donor roll then advances charged toner particles into contact with the latent image and any latent target marks. Development unit 26 may have a plurality of magnetic brush and donor roller members, plus rotating augers or other means for mixing toner and developer. These donor roller members transport negatively charged black toner particles for example, to the latent image for development thereof which tones the particular (first) color separation image areas and leaves other areas untoned. Power supply 32 electrically biases development unit 26. Development or application of the charged toner particles as above typically depletes the level and hence concentration of toner particles, at some rate, from developer material in the development unit 26. This is also true of the other development units (to be described below) of the machine 180.

On the second and subsequent passes of the multipass machine 180, the pair of corona devices 22 and 23 are employed for recharging and adjusting the voltage level of both the toned (from the previous imaging pass), and untoned areas on photoreceptor 10 to a substantially uniform level. A power supply is coupled to each of the electrodes of corona recharge devices 22 and 23. Recharging devices 22 and 23 substantially eliminate any voltage difference between toned areas and bare untoned areas, as well as to reduce the level of residual charge remaining on the previously toned areas, so that subsequent development of different color separation toner images is effected across a uniform development field.

Imaging device 24 is then used on the second and subsequent passes of the multipass machine 180, to superimpose subsequent a latent image of a particular color separation image, by selectively discharging the recharged photoreceptor 10. The operation of imaging device 24 is of course controlled by the controller, ESS 80. One skilled in the art will recognize that those areas developed or previously toned with black toner particles will not be subjected to sufficient light from the imaging device 24 as to discharge the photoreceptor region lying below such black toner particles. However, this is of no concern as there is little likelihood of a need to deposit other colors over the black regions or toned areas.

Thus on a second pass, imaging device 24 records a second electrostatic latent image on recharged photoreceptor 10. Of the four development units, only the second development unit 42, disposed at a second developer station EE, has its development function turned “on” (and the rest turned “off”) for developing or toning this second latent image. As shown, the second development unit 42 contains negatively charged developer material 40, for example, one including yellow toner. The toner 40 contained in the development unit 42 is thus transported by a donor roll to the second latent image recorded on the photoreceptor 10, thus forming additional toned areas of the particular color separation on the photoreceptor 10. A power supply (not shown) electrically biases the development unit 42 to develop this second latent image with the negatively charged yellow toner particles 40. As will be further appreciated by those skilled in the art, the yellow colorant is deposited immediately subsequent to the black so that further colors that are additive to yellow, and interact therewith to produce the available color gamut, can be exposed through the yellow toner layer.

On the third pass of the multipass machine 180, the pair of corona recharge devices 22 and 23 are again employed for recharging and readjusting the voltage level of both the toned and untoned areas on photoreceptor 10 to a substantially uniform level. A power supply is coupled to each of the electrodes of corona recharge devices 22 and 23. The recharging devices 22 and 23 substantially eliminate any voltage difference between toned areas and bare untoned areas, as well as to reduce the level of residual charge remaining on the previously toned areas so that subsequent development of different color toner images is effected across a uniform development field. A third latent image is then again recorded on photoreceptor 10 by imaging device 24. With the development functions of the other development units turned “off”, this image is developed in the same manner as above using a third color toner 55 contained in a development unit 57 disposed at a third developer station GG. An example of a suitable third color toner is magenta. Suitable electrical biasing of the development unit 57 is provided by a power supply, not shown.

On the fourth pass of the multipass machine 180, the pair of corona recharge devices 22 and 23 again recharge and adjust the voltage level of both the previously toned and yet untoned areas on photoreceptor 10 to a substantially uniform level. A power supply is coupled to each of the electrodes of corona recharge devices 22 and 23. The recharging devices 22 and 23 substantially eliminate any voltage difference between toned areas and bare untoned areas as well as to reduce the level of residual charge remaining on the previously toned areas. A fourth latent image is then again created using imaging device 24. The fourth latent image is formed on both bare areas and previously toned areas of photoreceptor 10 that are to be developed with the fourth color image. This image is developed in the same manner as above using, for example, a cyan color toner 65 contained in development unit 67 at a fourth developer station II. Suitable electrical biasing of the development unit 67 is provided by a power supply, not shown.

Following the black development unit 26, development units 42, 57, and 67 are preferably of the type known in the art which do not interact, or are only marginally interactive with previously developed images. For examples, a DC jumping development system, a powder cloud development system, or a sparse, non-contacting magnetic brush development system are each suitable for use in an image on image color development system as described herein. In order to condition the toner for effective transfer to a substrate, a negative pre-transfer corotron member negatively charges all toner particles to the required negative polarity to ensure proper subsequent transfer.

Since the machine 180 is a multicolor, multipass machine as described above, only one of the plurality of development units, 26, 42, 57 and 67 may have its development function turned “on” and operating during any one of the required number of passes, for a particular color separation image development. The remaining development units thus have their development functions turned off.

During the exposure and development of the last color separation image, for example by the fourth development unit 65, 67 a sheet of support material is advanced to a transfer station JJ by a sheet feeding apparatus 30. During simplex operation (single sided copy), a blank sheet may be fed from tray 15 or tray 17, or a high capacity tray 44 could thereunder, to a registration transport 21, in communication with controller 81, where the sheet is registered in the process and lateral directions, and for skew position. As shown, the tray 44 and each of the other sheet supply sources includes a sheet size sensor 31 that is connected to the controller 80. One skilled in the art will realize that trays 15, 17, and 44 each hold a different sheet type.

The speed of the sheet is adjusted at registration transport 21 so that the sheet arrives at transfer station JJ in synchronization with the composite multicolor image on the surface of photoconductive belt 10. Registration transport 21 receives a sheet from either a vertical transport 23 or a high capacity tray transport 25 and moves the received sheet to pretransfer baffles 27. The vertical transport 23 receives the sheet from either tray 15 or tray 17, or the single-sided copy from duplex tray 28, and guides it to the registration transport 21 via a turn baffle 29. Sheet feeders 35 and 39 respectively advance a copy sheet from trays 15 and 17 to the vertical transport 23 by chutes 41 and 43. The high capacity tray transport 25 receives the sheet from tray 44 and guides it to the registration transport 21 via a lower baffle 45. A sheet feeder 46 advances copy sheets from tray 44 to transport 25 by a chute 47.

As shown, pretransfer baffles 27 guide the sheet from the registration transport 21 to transfer station JJ. Charge can be placed on the baffles from either the movement of the sheet through the baffles or by the corona generating devices 54, 56 located at marking station or transfer station JJ. Charge limiter 49 located on pretransfer baffles 27 and 48 restricts the amount of electrostatic charge a sheet can place on the baffles 27 thereby reducing image quality problems and shock hazards. The charge can be placed on the baffles from either the movement of the sheet through the baffles or by the corona generating devices 54, 56 located at transfer station JJ. When the charge exceeds a threshold limit, charge limiter 49 discharges the excess to ground.

Transfer station JJ includes a transfer corona device 54 which provides positive ions to the backside of the copy sheet. This attracts the negatively charged toner powder images from photoreceptor belt 10 to the sheet. A detack corona device 56 is provided for facilitating stripping of the sheet from belt 10. A sheet-to-image registration detector 110 is located in the gap between the transfer and corona devices 54 and 56 to sense variations in actual sheet to image registration and provides signals indicative thereof to ESS 80 and controller 81 while the sheet is still tacked to photoreceptor belt 10.

The transfer station JJ also includes a transfer assist blade assembly 200. After transfer, the sheet continues to move, in the direction of arrow 58, onto a conveyor 59 that advances the sheet to fusing station KK.

Fusing station KK includes a fuser assembly, indicated generally by the reference numeral 60, which permanently fixes the transferred color image to the copy sheet. Preferably, fuser assembly 60 comprises a heated fuser roller 109 and a backup or pressure roller 113. The copy sheet passes between fuser roller 109 and backup roller 113 with the toner powder image contacting fuser roller 109. In this manner, the multi-color toner powder image is permanently fixed to the sheet. After fusing, chute 66 guides the advancing sheet to feeder 68 for exit to a finishing module (not shown) via output 64. However, for duplex operation, the sheet is reversed in position at inverter 70 and transported to duplex tray 28 via chute 69. Duplex tray 28 temporarily collects the sheet whereby sheet feeder 33 then advances it to the vertical transport 23 via chute 34. The sheet fed from duplex tray 28 receives an image on the second side thereof, at transfer station JJ, in the same manner as the image was deposited on the first side thereof. The completed duplex copy exits to the finishing module (not shown) via output 64.

After the sheet of support material is separated from photoreceptor 10, the residual toner carried on the photoreceptor surface is removed therefrom. The toner is removed for example at cleaning station LL using a cleaning brush structure contained in a unit 108.

The curling/decurling apparatus (which can comprise any of the apparatuses 600, 700, 800, 900 discussed above) is shown as being positioned along one portion of the media path within the structure shown in FIG. 10; however, as would be understood by one ordinarily skilled in the art, the curling/decurling apparatuses discussed herein can be positioned at any point along the media path within the structure shown in FIG. 10 depending upon the specific curling and/or decurling need within the machine 180. Further, multiple such curling/decurling apparatuses can be include within the machine 180.

The curler/decurler designs mentioned above utilized a combination of indentation and deformation mechanisms to generate curl controllability for a wide range of media, without excessive pressures or drive forces. The embodiments herein utilize soft roll penetration to curl light-weight sheets, and three-roll media wrap around for heavy weight sheets. This increases media latitude without increasing high nip pressures or drive torques. Further, the curling/decurling station is quite compact and can be manufactured so that the first set of rollers and the second set of rollers are separated by a small distance.

Many computerized devices are discussed above. Computerized devices that include chip-based central processing units (CPU's), input/output devices (including graphic user interfaces (GUI), memories, comparators, processors, etc., are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. An apparatus comprising:
a sheet path moving sheets of media within said apparatus; and
a curling/decurling station positioned along said sheet path, said curling/decurling station comprising:
a first set of rollers that impart or remove curl from a first type of sheets of media moving along said sheet path; and
a second set of rollers that impart or remove curl from a second type of sheets of media moving along said sheet path,
said first type of sheets having a different properties than said second type of sheets.

2. The apparatus according to claim 1, said first type of sheets having a different stiffness and a thickness than said second type of sheets.

3. The apparatus according to claim 1, further comprising a controller operatively connected to said first set of rollers and said second set of rollers, said controller controlling said first set of rollers and said second set of rollers such that only one of said first set of rollers and said second set of rollers is applied to any given sheet.

4. The apparatus according to claim 1, at least one roller of said first set of rollers being movable toward or away from said sheet path; and
at least one roller of said second set of rollers being movable toward or away from said sheet path.

5. The apparatus according to claim 1, said second set of rollers varying an amount of pressure to said first type of sheets and said second type of sheets depending upon said properties.

6. An apparatus comprising:
a sheet path moving sheets of media within said apparatus; and
a curling/decurling station positioned along said sheet path, said curling/decurling station comprising:
a first set of rollers that impart or remove curl from a first type of sheets of media moving along said sheet path; and
a second set of rollers that impart or remove curl from a second type of sheets of media moving along said sheet path,
said first type of sheets having a different properties than said second type of sheets,
said first set of rollers comprising:
a first roller on a first side of said sheet path; and
a second roller on a second side of said sheet path,
said first roller and said second roller being positioned on opposite sides of said sheet path such that said sheet path is positioned between said first roller and said second roller,
said first roller having a larger circumference and a more deformable outer layer than said second roller, such that said first set of rollers import or remove curl from said first type of sheets by pressing said first type of sheets into said first roller;
said second set of rollers comprising:
a pair of third rollers on said first side of said sheet path; and
a fourth roller on said second side of said sheet path, and
said fourth roller being positioned between said third rollers relative to a processing direction of said sheet path.

7. The apparatus according to claim 6, said first type of sheets having a different thickness and a thickness than said second type of sheets.

8. The apparatus according to claim 6, further comprising a controller operatively connected to said first set of rollers and said second set of rollers, said controller controlling said first set of rollers and said second set of rollers such that only one of said first set of rollers and said second set of rollers is applied to any given sheet.

9. The apparatus according to claim 6, at least one roller of said first set of rollers being movable toward or away from said sheet path; and
at least one roller of said second set of rollers being movable toward or away from said sheet path.

10. The apparatus according to claim 6, said second set of rollers varying an amount of pressure to said first type of sheets and said second type of sheets depending upon said properties.

11. An apparatus comprising:
a sheet path moving sheets of media within said apparatus; and
a curling/decurling station positioned along said sheet path, said curling/decurling station comprising:
a first set of rollers that impart or remove curl from a first type of sheets of media moving along said sheet path; and
a second set of rollers that impart or remove curl from a second type of sheets of media moving along said sheet path,
said first type of sheets having a different properties than said second type of sheets,
said first set of rollers comprising:
a first roller on a first side of said sheet path; and
a second roller on a second side of said sheet path,
said first roller and said second roller being positioned on opposite sides of said sheet path such that said sheet path is positioned between said first roller and said second roller,
said first roller having a larger circumference and a more deformable outer layer than said second roller, such that said first set of rollers import or remove curl from said first type of sheets by pressing said first type of sheets into said first roller;
said second set of rollers comprising:
said first roller on said first side of said sheet path; and
a third roller on said second side of said sheet path, and
said second roller being positioned between said first roller and said third roller relative to a processing direction of said sheet path.

12. The apparatus according to claim 11, said first type of sheets having a different stiffness and a thickness than said second type of sheets.

13. The apparatus according to claim 11, further comprising a controller operatively connected to said first set of rollers and said second set of rollers, said controller controlling said first set of rollers and said second set of rollers such that only one of said first set of rollers and said second set of rollers is applied to any given sheet.

14. The apparatus according to claim 11, at least one roller of said first set of rollers being movable toward or away from said sheet path; and
at least one roller of said second set of rollers being movable toward or away from said sheet path.

15. The apparatus according to claim 11, said second set of rollers varying an amount of pressure to said first type of sheets and said second type of sheets depending upon said properties.

16. An apparatus comprising:
a sheet path moving sheets of media within said apparatus; and
a curling/decurling station positioned along said sheet path,
said curling/decurling station comprising:
a first set of rollers that impart or remove curl from a first type of sheets of media moving along said sheet path; and
a second set of rollers that impart or remove curl from a second type of sheets of media moving along said sheet path,
said first type of sheets having a different properties than said second type of sheets,
said first set of rollers comprising:
a first roller on a first side of said sheet path; and
a second roller on a second side of said sheet path,
said first roller and said second roller being positioned directly across from each other on opposite sides of said sheet path such that said sheet path is positioned between said first roller and said second roller,
said first roller having a larger circumference and a more deformable outer layer than said second roller, such that said first set of rollers import or remove curl from said first type of sheets by pressing said first type of sheets into said first roller;
said second set of rollers comprising:
a pair of third rollers on said first side of said sheet path; and
said second roller on said second side of said sheet path, and
said first roller and said second roller being positioned between said third rollers relative to a processing direction of said sheet path.

17. The apparatus according to claim 16, said first type of sheets having a different stiffness and a thickness than said second type of sheets.

18. The apparatus according to claim 16, further comprising a controller operatively connected to said first set of rollers and said second set of rollers, said controller controlling said first set of rollers and said second set of rollers such that only one of said first set of rollers and said second set of rollers is applied to any given sheet.

19. The apparatus according to claim 16, at least one roller of said first set of rollers being movable toward or away from said sheet path; and
at least one roller of said second set of rollers being movable toward or away from said sheet path.

20. The apparatus according to claim 16, said second set of rollers varying an amount of pressure to said first type of sheets and said second type of sheets depending upon said properties.
